(19) United States
(12) Patent Application Publication
(10) Pub. No.: US 2003/0197054 A1
(43) Pub. Date: Oct. 23, 2003

(54) Intellectual property identification and recording system

(76) Inventor: Baden Eunson, Bentleigh (AU)

Correspondence Address: Baden Eunson, 38 Leckie Street, Bentleigh, 3204, AU

(21) Appl. No.: 09/752,323

(22) Filed: Dec. 22, 2000

(30) Foreign Application Priority Data
May 12, 1998 (WO) PCT/AU98/00338
May 12, 1998 (WO) WO 99/59102

(51) Int. Cl. G06F 17/00

(52) U.S. Cl. 235/375

(57) ABSTRACT

An intellectual property identification and recording system is disclosed. Printed material such as pages from a book or serial can be identified by a machine readable bar code. Reading or scanning devices placed in photocopiers can recognize such data, and such data can then be recorded. Such data can be used as a basis for calculating a fee or payment to creators and/or copyright holders of intellectual property whose property is reproduced.

### CROSS-REFERENCE TO RELATED APPLICATIONS

International Application Number: PCT/AU98/00338.

International Publication Number: WO 99/59102.

International Filing Date: May 12, 1998.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention combines elements of identification technology (bar coding), reproduction technology (photocopying) and data storage and collection technology (hard disk).

### BRIEF SUMMARY OF THE INVENTION

This invention relates to a system allowing items of printed material to be identifiable via bar coding when being photocopied or reproduced.

Photocopying of books, articles, illustrations and other material takes place extensively across the world. In many countries, there are legal limitations upon the amount of printed material that can or should be photocopied, often enshrined in concepts such as “fair dealing.” These limitations are meant to be enforced by a series of administrative arrangements (e.g., display of warnings about violations of fair dealing, recording of details of all photocopying), but it is often difficult to enforce such limitations, particularly in institutions with substantial photocopying facilities (e.g., educational, public and corporate libraries).

Anecdotal evidence suggests that unauthorized photocopying takes place on a large scale in countries with legal prohibitions on such unauthorized use, and may also take place in countries with non-existent or only rudimentary systems of limited use.

Such unauthorized use is in effect violation of the intellectual property of authors, artists and publishers. It leads to creators being denied income that is rightfully theirs. This process is analogous to software and record/tape piracy, and might well be termed “print piracy.”

There is a need for a system that can automatically record the level of copying of any given specific work across a wide range of photocopying machines. Such data could then be used to calculate a reimbursement or usage fee that could then be given to owners of intellectual property.

### BRIEF DESCRIPTION OF THE SEVERAL VIEWS OF THE DRAWINGS

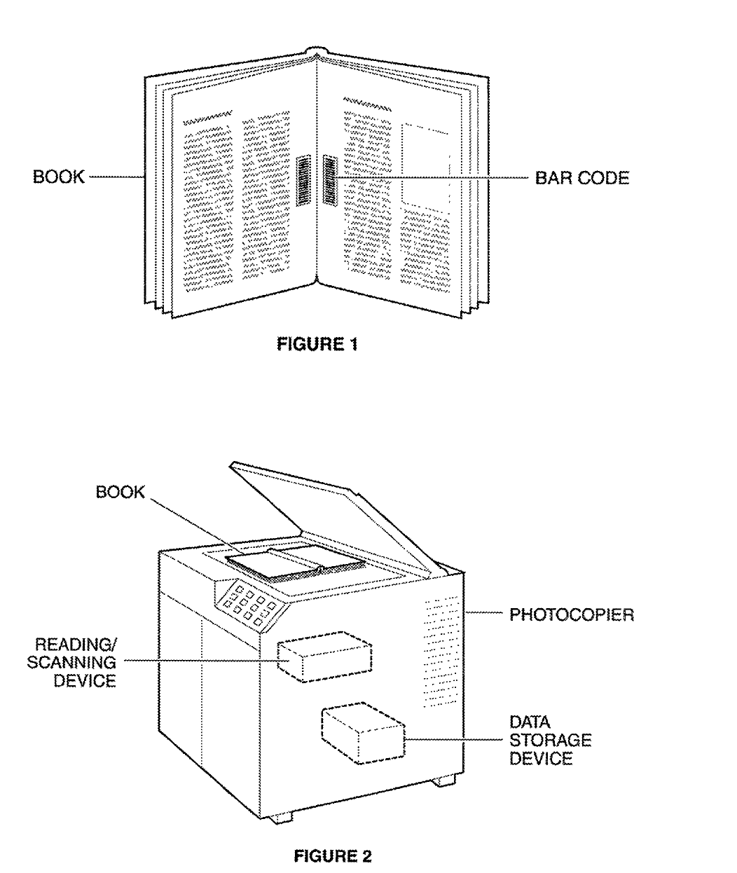

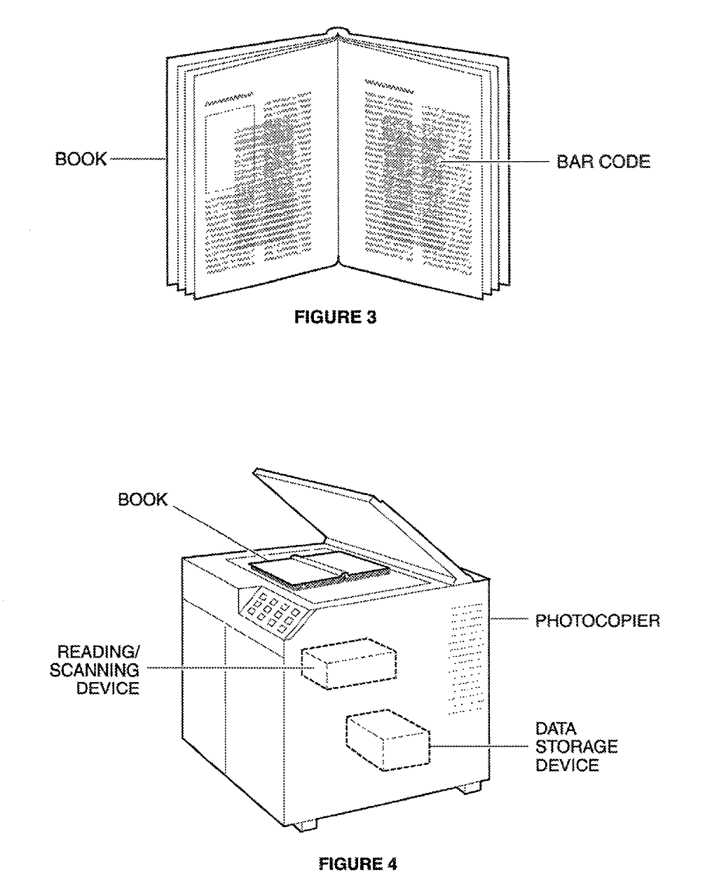

The drawings shows how details of an item of property (e.g., the page of a book) identified with a barcode would be identified and recorded when that item was photocopied. FIGS. 1 and 2 show a conventional laser-read barcode could be positioned in the margin of book, and the accompanying photocopying process, while FIGS. 3 and 4 show how a barcode might be created by other means to cover a substantial part of the page.

### DETAILED DESCRIPTION OF THE INVENTION

All books published are issued with an ISBN (International Standard Book Number). This can be converted to a bar code, and indeed is now often reproduced on the cover of a given book for pricing and inventory purposes.

The bar code unique to a book could be reproduced on each page of the book—for example, in the centre margin. This, however, might be aesthetically unattractive, and might not be completely effective (e.g., the curvature of the page at that point might mean that a clear image of the barcode cannot be captured).

A less obtrusive and perhaps more effective method might be to stretch out the barcode so that it appears in a thin strip along one or several margins of the page.

Both of these approaches would be suitable for use with laser readers, which read off carbon or optically-dark material.

It may be even more preferable to have a rendering of the barcode information in such a way that it is not immediately obvious to the human eye. For example, an “invisible watermarking” system might be used, whereby information is printed onto specially treated paper, together with book text, which only becomes visible when photocopying takes place.

Alternately, the bar code might be attached using special ink, dye, etching, film, electronic, or other processes (e.g., via application of material only visible in infrared or ultraviolet light) over or under the normal text and graphics on a page or in a page. Using such systems would mean that the barcode could be quite large, taking up perhaps 80-100% of the page or section of a page, thus making it easier to register or capture an image of the barcode.

These non-dark-material or carbon-formed barcodes would require reading or recognition systems different from those used in conventional laser/barcode systems.

A “catch-up” system might also be possible for books already in print, whereby a rubber stamp or other overprinting system coding could be created for each book, and each page could then be stamped or identified.

Bar code readers could be placed in all photocopiers where substantial degrees of photocopying takes place (e.g., educational/public/corporate libraries and reproduction centres), together with a memory device such as a hard disk. Organizations charged with responsibility of monitoring photocopying and copyright matters (such as the Australian federal government agency CAL [Copyright Agency Limited]) would then collect this data periodically (either physically, or through on-line means), thus giving them an accurate and systematic data base for the collection of copyright fees, for eventual repayment to owners of intellectual property such as authors and publishers.

The system is primarily an open one—that is, its prime purpose is to facilitate financial compensation for intellectual property creators and managers, and not to prevent reproduction or to permit only authorized reproduction.

The costs of the system would be covered by increasing the unit/sheet copying fee charged.

A similar arrangement could be made for journal articles, whereby the ISSN (International Standard Serial Number), together with a suffix unique to each article, could be converted to a barcode.

Another International Standard Number system could be created for other items (e.g., students' essays/papers, works of art, etc).

The success or failure of such a system will depend upon technical and human/institutional factors.

It would obviously be preferable if a single system (e.g., laser, non-laser) were to be chosen. Substantial research may be needed to identify the most optimal identification system, and then integrate it into the photocopying process.

Once such a system had been agreed upon, there would need to be negotiation of arrangements between

(a) publishers, authors and other creators

(b) photocopier manufacturers

(c) bar code reader manufacturers

(d) paper manufacturers (if special papers with sub-visible bar codes, rather than normal papers with visible bar codes printed in margins, were the preferred option)

(e) owners of other proprietary identification systems

(f) printers

(g) photocopier owners and/or administrators (e.g., managers of educational institutions)

(h) copyright protection agencies (usually nationally based)

(i) governments

(j) users.

While such negotiations would be involved, all parties, with the possible exception of users, would benefit monetarily. As such, there are strong incentives to undertake such arrangements.

Such technical problems as there might be in integrating the component parts can almost certainly be overcome, given the monetary incentives operating, and also should be overcome, given the natural justice argument inherent in this situation: it is only right that creators of intellectual property should receive the fullest possible compensation for the use of that property by others.

The system should ideally be a simple combination of existing technologies, and thus should not prove to be difficult to implement.

The system would entail changes in printing procedures, and this may prove to be technically challenging.

The system also only applies to photocopiers, and not to reproduction facilities such as printing presses, where a single master copy taken from a photocopy would be used. In such situations, it seems that only administrative arrangements, such as ethical observation of legal requirements and recording of copying details, could be used to facilitate payment to intellectual property creators.

The claims defining the invention are as follows:

1. A system of identifying and recording details of printed intellectual property comprising bar coding data detectable when such property is being photocopied or reproduced.

2. The intellectual property identification and recording system of claim 1 wherein identification and recording takes place using conventional or modified laser scanning systems.

3. The intellectual property identification and recording system of claim 1 wherein identification and recording takes place using non-laser scanning systems.

4. An open system of identifying and recording details of intellectual property comprising bar coded data, primarily for the purpose of facilitating financial compensation to intellectual property creators and managers, and not to prevent reproduction.

5. An open system of identifying and recording details of intellectual property comprising bar coded data, primarily for the purpose of facilitating financial compensation to intellectual property creators and managers, and not to permit only authorized reproduction.

6. An intellectual property identification and recording system substantially as herein described with reference to the accompanying drawings.
